(19) United States
(12) Patent Application Publication
(10) Pub. No.: US 2017/0324283 A1
(43) Pub. Date: Nov. 9, 2017

(54) IPT COMMUNICATION SYSTEM FOR DYNAMIC PAIRING

(71) Applicant: PowerbyProxi Limited, Freemans Bay, Auckland (NZ)

(72) Inventor: Robert WALTON, Freemans Bay, Auckland (NZ)

(73) Assignee: PowerbyProxi Limited, Freemans Bay, Auckland (NZ)

(21) Appl. No.: 15/526,692

(22) PCT Filed: Nov. 12, 2015
(86) PCT No.: PCT/NZ2015/050191

§ 371 Date: May 12, 2017

Related U.S. Application Data
(60) Provisional application No. 62/079,482, filed on Nov. 13, 2014.

(51) Int. Cl. H02J 50/80; H02J 50/12; H04B 5/00; H04L 27/00

(52) U.S. Cl. CPC H02J 50/80; H04L 27/0008; H02J 50/12; H04B 5/0093

(57) ABSTRACT

An IPT system 1 including: an IPT transmitter 2 including a drive circuit 6 for varying the current supplied to a primary coil 7; an IPT receiver 3 including a pick up coil 9 magnetically coupled with the primary coil 7; a first magnetic near field communication system for transmitting access data via magnetic coupling between the primary and pick up coils; and a second communication system 13 for transmitting information between the IPT receiver and the IPT transmitter that utilises the access data to encode and decode communications sent via the second communications system.

### FIELD OF THE INVENTION

The present invention relates to communication in an inductive power transfer (IPT) system. More particularly, but not exclusively, the invention relates to a method and system for pairing IPT transmitters and receivers and providing secure communication in an IPT system.

### BACKGROUND OF THE INVENTION

It is known to communicate between IPT transmitters and receivers using a range of communication techniques. Near-field communication (NFC) is a form of short-range wireless communication either by a modulated electric field, or a modulated magnetic field, but not by radio (electromagnetic waves). It is known to use magnetic NFC for communication between IPT transmitters and receivers. However, communication may be degraded during operation where noise and resonant tuning may make it difficult to distinguish signals from noise and as a consequence communications bandwidth is limited. Further, where multiple IPT receivers are employed cross-talk between devices may be a problem.

It is also known to communicate between IPT transmitters and receivers using far-field communication techniques such as radio frequency communication. Such communications are by their nature insecure and with multiple devices there is potential for cross-talk between devices.

The invention provides a method and system for pairing IPT transmitters and receivers that provides secure communication in an IPT system, or at least provides the public with a useful choice.

### SUMMARY OF THE INVENTION

According to one exemplary embodiment there is provided a method of communicating in an IPT system comprising:
a. transmitting access data from an IPT transmitter to and IPT receiver using magnetic near-field communication utilising primary and pick up coils of the IPT system; and
b. sending encoded data between the IPT transmitter and the IPT receiver utilising the access data to encode communications; and
c. decoding communications between the IPT transmitter and the IPT receiver utilising the access data.

According to another exemplary embodiment there is provided an IPT system including:
a. an IPT transmitter including a drive circuit for varying the current supplied to a primary coil;
b. an IPT receiver including a pick up coil magnetically coupled with the primary coil;
c. a first magnetic near field communication system for transmitting access data via magnetic coupling between the primary and pick up coils; and
d. a second communication system for transmitting information between the IPT receiver and the IPT transmitter that utilises the access data to encode and decode communications sent via the second communications system.

“Magnetic near-field communication” when used in this specification means short-range wireless communication via a modulated magnetic field.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a general representation of an inductive power transfer system;

FIG. 2 shows an IPT transmitter inverter and controller;

FIG. 3 shows an IPT receiver detection circuit;

FIGS. 4a and 4b show a delay method for producing frequency modulation;

FIG. 5 illustrates schematically frequency modulation of access data; and

FIG. 6 illustrates cycle by cycle frequency modulation of access data.

### DETAILED DESCRIPTION OF EMBODIMENTS OF THE INVENTION

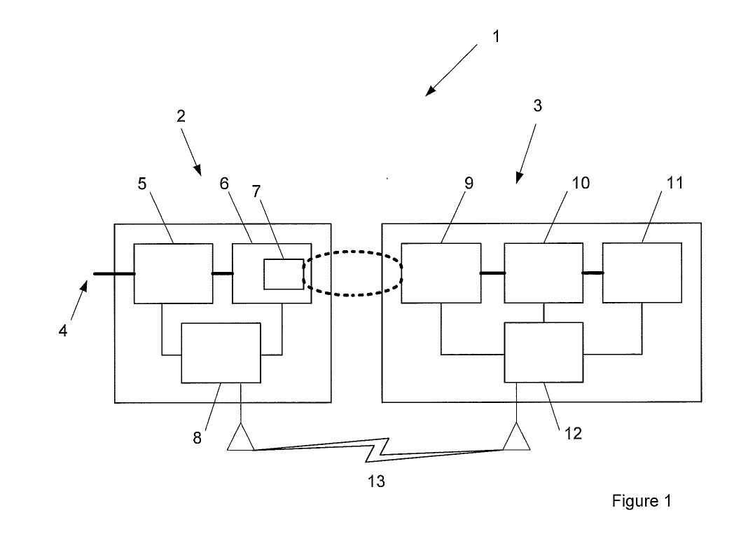

FIG. 1 shows a representation of an IPT system 1. The IPT system includes an IPT transmitter 2 and an IPT receiver 3. The IPT transmitter is connected to an appropriate power supply 4 (such as mains power). The IPT transmitter may include an AC-DC converter 5 that is connected to an inverter 6. The inverter supplies a primary coil or coils 7 with an alternating current so that the primary coil or coils generate an alternating magnetic field. In some configurations, the primary coils may also be considered to be separate from the inverter. The transmitting coil or coils may be connected to capacitors (not shown) either in parallel or series to create a resonant circuit.

FIG. 1 also shows a controller 8 within the IPT transmitter 2. The controller may be connected to each part of the IPT transmitter. The controller may be adapted to receive inputs from each part of the IPT transmitter and produce outputs that control the operation of each part. Those skilled in the art will appreciate that the controller may be implemented as a single unit or separate units. Those skilled in the art will appreciate that the controller may be adapted to control various aspects of the inductive power transmitter depending on its capabilities, including for example: power flow, tuning, selectively energising primary coils, inductive power receiver detection and/or communications.

The IPT receiver 3 includes a pick up coil (or coils) 9 that is connected to power flow control circuit 10 that in turn supplies power to a load 11. When the IPT transmitter 2 and IPT receiver are suitably coupled, the alternating magnetic field generated by the primary coil 7 induces an alternating current in the pick up coil 9. The power flow control circuit 10 is adapted to convert the induced current into a form that is appropriate for the load. The pick up coil may be connected to capacitors (not shown) either in parallel or series to create a resonant circuit. The receiver may include a controller 12 which may control the tuning of the receiving coil or the power supplied to the load by the receiving circuitry as well as communications. In the embodiment shown an RF communications link 13 is shown between controller 8 and controller 12.

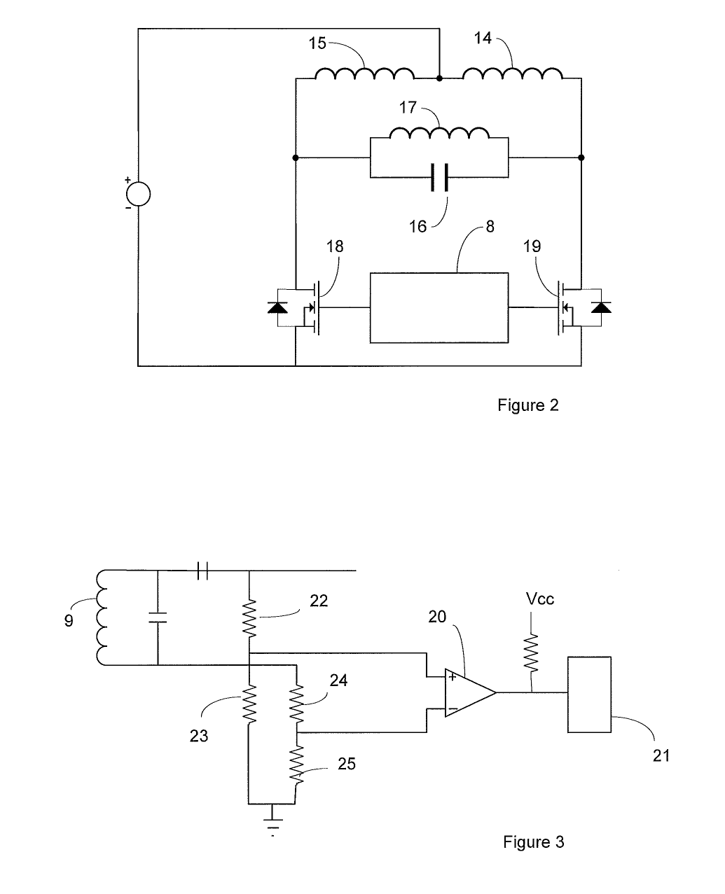

Referring now to FIG. 2 a drive circuit of an inverter 7 which in this embodiment is shown as a push-pull topology including inductors 14 and 15 splitting into two branches with a resonant circuit formed by resonant capacitor 16 and a primary coil 17 in parallel across the branches. Switches in the form of FETs 18 and 19 are controlled by controller 8 based on feedback from each branch at zero crossings to alternately drive the resonant circuit.

In this embodiment controller 8 generates or has a store of access codes to allocate to IPT receivers during pairing. During initialisation or start up an access code may be transmitted to an IPT receiver to be paired which may include a unique device ID and/or an encryption key. By sending the access code during start up interference that may occur during normal operation may be avoided and the drive circuit may be dedicated to communication. The access code will be in digital form and is preferably used to frequency modulate drive signals to switches 18 and 19 to transmit the access code to an IPT receiver using magnetic near-field communication.

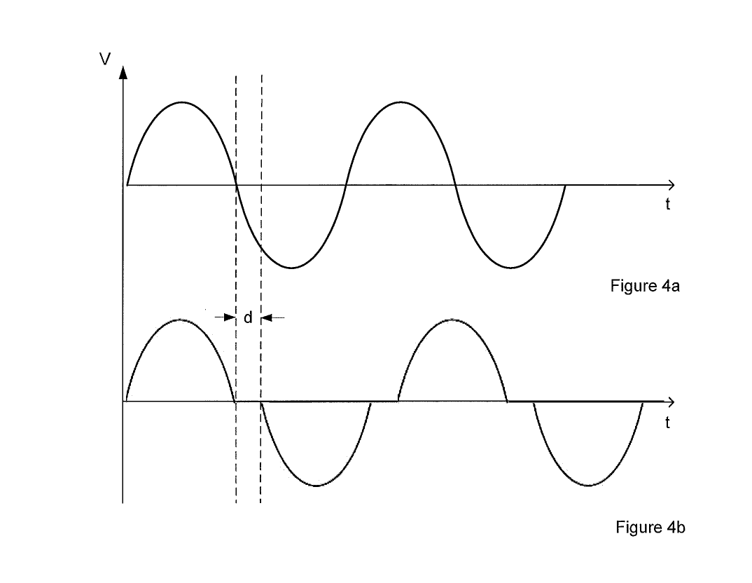

A preferred method to achieve frequency modulation is to introduce delay into drive signals provided to switches 18 and 19. In the example shown in FIGS. 4a and 4b a “zero” bit has no delay (FIG. 4a) and results in an operating frequency fR and a “one” has a delay “d” applied (FIG. 4b) and results in an operating frequency fL. However, both states could also be delayed by different amounts.

The delay is preferably applied at zero crossings for ease of implementation and to minimise losses. By introducing this delay frequency modulation may be achieved based on the value of successive bits of an access code.

FIG. 3 shows an exemplary IPT receiver demodulation circuit in which the voltage at each terminal of pick up coil 9 is supplied by resistor dividers 22 and 23 and 24 and 25 to the inverting and non-inverting terminals of comparator 20. Comparator 20 changes its output, supplied to a microprocessor 21, at each zero crossing point. The state change of the comparator 21 at each zero crossing point has a direct relationship to the frequency of the current induced in pick up coil 9.

The microprocessor 21 counts the number of zero crossings received from the comparator 20 in a given period of time. Multiple counts are taken during any one IPT transmitter modulation bit period and this is done for reasons of bit edge detection. A phase lock loop (PLL) algorithm is used in microprocessor 21 to determine a median above or below which a logical level 1 or 0 is determined (see FIG. 6).

FIG. 6 shows a three bit sequence where X is one count and Y is a different count of zero crossings. Where the count X is above the median the sub-bit logic level is a 0 and where count Y is below the median a logic level of 1 is derived. Algorithms on the sub-bit stream are used to convert sub-bits to bits and bits to bytes or words and these can then be used to decode the operational data which was encoded by the IPT transmitter.

In a preferred embodiment when a IPT receiver 3 receives power from an IPT transmitter 2 it sends an RF wake-up signal to the IPT transmitter 3 via RF communications link 13. When the IPT transmitter 2 receives the wake-up it creates a unique code and modulates this code onto the drive signals to switches 18 and 19 as described above. When IPT receiver 3 receives the unique access code it uses this code to establish a private RF link on the RF communications link. When an IPT receiver loses power the IPT transmitter reverts back to listening for a receiver and repeating the pairing process. In this way dynamic pairing allows any transmitter to pair with any receiver, each time negotiating a private secondary communications channel which prevents cross talking.

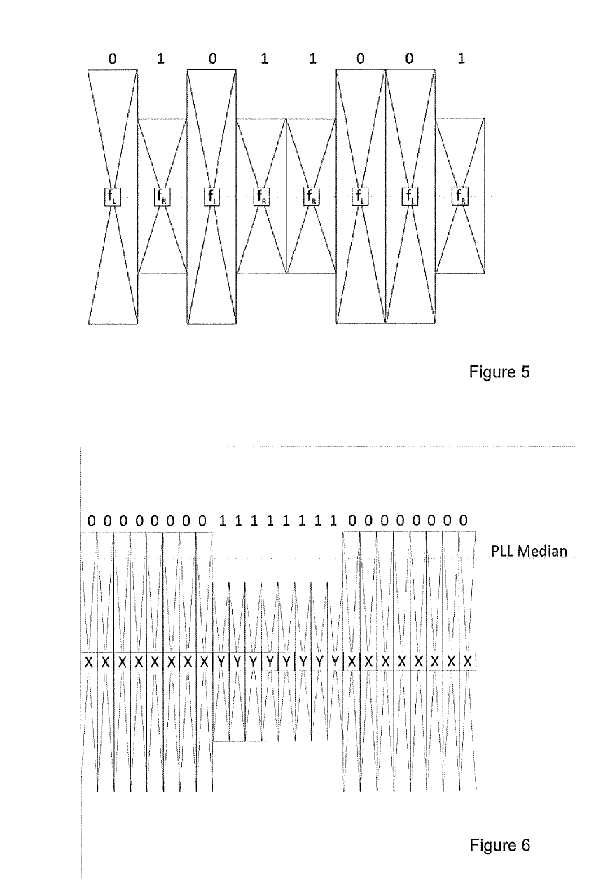

FIG. 5 shows that switching the frequency between fL and fR can be used as a method to create a binary bit stream. There is theoretically no limit to the bit stream length and the only penalty is a reduction in power transfer capability between the IPT transmitter and receiver during near-field communications.

There is thus provided a method of communication and system that enables secure dynamic pairing or IPT transmitters and receivers. This allows secure communication and ensures that the IPT transmitter information can only be correctly received by the IPT receiver to which it is coupled.

This approach avoids crosstalk between multiple IPT transmitter and receiver pairs—which is undesirable or potentially hazardous. It is compatible with RF and coil based communication systems and utilises existing components, resulting in simple and inexpensive solution.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of communicating in an IPT system comprising:
a. transmitting access data from an IPT transmitter to and IPT receiver using magnetic near-field communication utilising primary and pick up coils of the IPT system; and
b. sending encoded data between the IPT transmitter and the IPT receiver utilising the access data to encode communications; and
c. decoding communications between the IPT transmitter and the IPT receiver utilising the access data.

2. A method as claimed in claim 1 wherein the encoded data is sent via a communication type other than near-field communication, via electromagnetic radiation, or via radio frequency radiation.

3. (canceled)

4. (canceled)

5. A method as claimed in claim 1 wherein drive signals supplied to the primary coil are modulated based on the access data.

6. A method as claimed in claim 5 wherein the modulation is frequency modulation of the drive signals.

7. A method as claimed in claim 6 wherein modulation is achieved by delaying drive signals between cycles.

8. A method as claimed in claim 7 wherein the delay is performed at zero crossings.

9. A method as claimed in claim 7 wherein each bit of the access code causes a different delay for a predetermined number of cycles.

10. A method as claimed in claim 9 wherein the access code is decoded by counting the number of cycles with respect to a phase locked loop.

11. A method as claimed in claim 1 wherein the access data is an encryption key.

12. A method as claimed in claim 1 wherein the access data includes an identification code allocated to an IPT receiver.

13. A method as claimed in claim 1 wherein access data is exchanged during system start up.

14. A method as claimed in claim 1 wherein both magnetic near-field communication and communication of a type other than near-field communication are employed to pair a device.

15. An IPT system including:
a. an IPT transmitter including a drive circuit for varying the current supplied to a primary coil;
b. an IPT receiver including a pick up coil magnetically coupled with the primary coil;
c. a first magnetic near field communication system for transmitting access data via magnetic coupling between the primary and pick up coils; and
d. a second communication system for transmitting information between the IPT receiver and the IPT transmitter that utilises the access data to encode and decode communications sent via the second communications system.

16. An IPT system as claimed in claim 15 wherein the IPT transmitter includes a modulation circuit for modifying operation of the drive circuit to modulate drive signals supplied to the primary coil in dependence upon access data supplied to modulation circuit.

17. An IPT system as claimed in claim 16 wherein the modulation circuit varies the operating frequency of the drive circuit.

18. An IPT system as claimed in claim 17 wherein the modulation circuit delays resonant circuit drive signals between cycles according to the status of each bit of the access data.

19. An IPT system as claimed in claim 18 wherein a delay is applied when the status of a bit is a first value and is not applied when the status of a bit is a second value, or the delay is applied at zero crossings.

20. (canceled)

21. An IPT system as claimed in claim 15 wherein the IPT receiver includes a demodulation circuit that receives signals induced in the pick up coil and demodulates them to generate the access data.

22. An IPT system as claimed in claim 21 wherein the demodulation circuit includes a frequency detection circuit for capturing frequency information.

23. An IPT system as claimed in claim 15 wherein the second communication system uses a far-field communication technique or radio frequency communications.

24. (canceled)
